(19) United States
(12) Patent Application Publication
(10) Pub. No.: US 2025/0187014 A1
(43) Pub. Date: Jun. 12, 2025

(54) DEVICE FOR CONNECTING A FLEXIBLE TUBE OR PIPE, PREFERABLY A CAPILLARY

(71) Applicant: Möller Medical GmbH & Co KG, Fulda (DE)

(72) Inventors: Frank HIRMER, Schlitz (DE); Michael FRANK, Grossenlüder (DE)

(21) Appl. No.: 19/053,654

(22) Filed: Feb. 14, 2025

Related U.S. Application Data
(63) Continuation of application No. 17/602,986, filed on Jan. 21, 2022.

(30) Foreign Application Priority Data
Apr. 10, 2019 (DE) 10 2019 002 641.1

(51) Int. Cl. B01L 3/00

(52) U.S. Cl. CPC B01L 3/563; B01L 2200/025; B01L 2200/0689; B01L 2300/042; B01L 2300/0838; B01L 2300/123

(57) ABSTRACT

The present invention relates to a device for connecting a tube or hose, preferably a capillary, comprising a core element having a threaded section for connecting to a connection socket, and a cap element which extends around the core element in the peripheral direction offset from the threaded section in a longitudinal direction, wherein the core element and the cap element are rotationally coupled to one other in a way that a torque applied to the cap element is transferred to the core element, and above a threshold of the torque in a screw-in rotational direction of the core element a relative movement of the cap element is performed relative to the core element instead of the transfer of torque, wherein an intermediate element for providing a coupling between the core element and the cap element is arranged.

### CROSS REFERENCE TO RELATED APPLICATIONS

This application claims priority to U.S. patent application Ser. No. 17/602,986 filed on Jan. 21, 2022, which claim priority to International Patent Application No. PCT/EP2020/060294 filed on Apr. 9, 2020, which claims priority to German Patent Application DE 10 2019 002 641.1 filed on Apr. 10, 2019, the entire disclosures of which are hereby incorporated by reference and relied upon.

### BACKGROUND OF THE INVENTION

### Field of the Invention

The present invention relates to a device for connecting a tube or hose, preferably a capillary.

### Description of Related Art

It is known that for connecting a tube or hose, preferably a capillary, or for connecting two capillaries, respective devices, which are also called “fitting”, are used. By screwing the device to a respectively formed threaded connection bushing, a sealing element accommodated in the fitting may be pressed against a wall opposite thereto of the threaded connection bushing by means of a high pressure force. DE 10 2009 022 368 B3 and WO 2017/194193 A1 each disclose such a fitting for connecting of capillaries.

In addition, it is known to configure fitting systems for capillaries, tube, or hose connections in a way that, analogous to a ratchet, a torque may be transferred only up to a predetermined limit/threshold at least in a screw-in direction of the device and/or of the fitting. Said devices are also called “torque fittings”. Their areas of application are wide ranging. Capillary connections are used in assemblies having little installation space which do not provide a space for standard fittings, and which have to be screwed-in by torque wrenches. They are also used to facilitate handling, as for example during maintenance intervals, where replacement-hoses, tubes and/or capillaries often have to be replaced.

However, known torque fittings also have their limitations. Said limitations are even exclusion criteria for user of torque fittings, and especially regarding demanding applications, as for example in chemical, pharmaceutical and medical techniques, as for example in the specialist areas for HPFC and analytics systems, but also in the food processing industry, for example. For such applications the drawbacks listed in the following are not acceptable.

Known torque fittings are normally configured as two parts. An inner part acts as carrying core element having a thread, while an outer part, which is configured as cap element, serves as a handle. Both components, core element and cap element are made from plastic. The torque feature or function between the threaded core element and the cap element having a handle is an overload-ratchet-coupling. During tightening of the torque fitting in a screw connection, the free resilient plastic spring elements spring back when reaching the threshold of the torque. In other words, the plastic caps “rattles through” against the plastic core. During releasing of the screw connection, said spring elements hook in a way that the fitting may be screwed off.

An advantage of the torque fittings is the functioning thereof during spring back of the plastic which is formed between the core and the cap element as a spring element, and thus forms the ratchet element in a simple way. A further advantage is the cost-efficient manufacturing of core element and cap element of the torque fitting from plastic by means of well-known plastic injection molding.

A disadvantage of such a torque fitting configuration is that the core element is made from plastic. Plastic threads frequently exhibit an unfavorable setting behavior. The fitting seat in the screw connection must thus be checked, as otherwise a leakage or dead volume may be generated in the connection system. In addition, for thread variants or design changes of the end-face connection of the core element, a new injection molding tool is required for every manufacturing process.

### BRIEF SUMMARY OF THE INVENTION

Based on the known state of the art, it is an object of the present invention to provide an enhanced device for connecting a tube or hose, preferably a capillary.

Said object is solved by a device for connecting a tube or hose, preferably a capillary, by means of the features of claim 1. Advantageous developments result from the dependent claims, the specification, and the figures.

Correspondingly, a device for connecting a tube or hose, preferably a capillary, is proposed, comprising a core element having a threaded section for connecting to a connection socket, and a cap element which extends offset from the threaded section in the peripheral direction around the core element in a longitudinal direction, wherein the core element and the cap element are rotationally coupled to one other in a way that a torque applied to the cap element is transferred to the core element, and above a threshold of the torque in a screw-in rotational direction of the core element a relative movement of the cap element is performed relative to the core element instead of the transfer of torque. According to the invention, an intermediate element is arranged between the core element and the cap element for providing a coupling between the core element and the cap element.

As an intermediate element is provided between the core element and the cap element for providing a coupling between the core element and the cap element, a material may be assigned to the core element which is especially suitable regarding a screw connection. Thus, as compared to prior art, a setting behavior of the threaded section of the core element may be reduced. At the same time, the intermediate element may be further improved regarding a “ratchet feature” between the intermediate element and the cap element by selecting a material different from the core element.

According to a preferred embodiment, the core element comprises a metal or a metal alloy. On metal threads much larger forces may be applied and transferred by them as this is the case for torque fittings having a plastic core element and/or plastic thread. Further, metals exhibit a reduced setting behavior, in particular compared to plastic materials. This allows a higher long-term stability as compared to traditional torque fittings, amongst others. By forming the core element as a threaded metal part, the drawbacks of the setting behavior for plastic threads may be overcome. Further, the core element may be configured as a turned part. Design changes may thus be implemented easily without causing tool costs for a new or extensively changed plastics injection molding tool. Higher forces may act on a core element made of metal having a metal thread as on a traditional core element having a plastic thread.

Alternatively, the core element may also comprise a plastic material.

According to a preferred embodiment, the cap element comprises a plastic material and/or the intermediate element comprises a plastic material. This way, the advantageous characteristics of plastic regarding the coupling between the intermediate element and the coupling element, and the intermediate element and the core element may be leveraged.

Advantageously, the plastic material of the core element, the intermediate element and/or of the cap element is a plastic material which is reinforced by a reinforcing material, preferably ceramics, glass, or carbon, for example a composite material.

According to a preferred embodiment, the intermediate element is fixedly arranged on the core element, wherein preferably the intermediate element is an overmolding, preferably a plastic overmolding, of the core element. This way, a fixed connection between the core element and the intermediate element may be achieved, which in particular enables a permanent transfer of torque between the core element and the intermediate element.

Alternatively, the intermediate element may also be applied on the core element by means of 3D printing, sintering, or pressing.

According to a preferred embodiment, a positive locking between the intermediate element and the core element is formed in a positive locking section in the peripheral direction. This way it may be ensured that the intermediate element is not released from the core element even at high torques.

According to a preferred embodiment the intermediate element comprises at least one resilient spring element which is in engagement with an engagement portion of the cap element, preferably a plurality of spring elements which are distributed in the peripheral direction preferably in a uniform way, wherein the at least one resilient spring element is formed in a way that below the threshold a transfer of torque may be performed in both rotational directions, and above the threshold the spring element experiences a resilient deformation in the screw-in rotational direction, thus a relative movement between the cap element and the intermediate element is possible. Preferably, the spring element is further configured in a way that a transfer of torque may always be performed against the screw-in rotational direction.

Alternatively, the cap element comprises at least one resilient spring element which is in engagement with an engagement portion of the intermediate element, preferably a plurality of spring elements which are distributed in the peripheral direction preferably in a uniform way, wherein the resilient spring element is formed in a way that below the threshold a transfer of torque may be performed in both rotational directions, and above the threshold the spring element experiences a resilient deformation in the screw-in rotational direction, thus a relative movement between the cap element and the intermediate element is possible. Preferably, the spring element is further configured in a way that a transfer of torque may always be performed against the screw-in rotational direction.

Advantageously, the core element is configured as turned part. This enables a simple and cost efficient manufacturing of the core element and ad-hoc design changes.

According to a preferred embodiment, a sealing element, a pressure or thrust part, a rotational lock, a child-proof lock, and/or a predetermined breaking point is further provided preferably on the core element. This way, the functionality of the device may further be improved, and specific applications may be enabled.

### BRIEF DESCRIPTION OF THE SEVERAL VIEWS OF THE DRAWINGS

These and other features and advantages of the present invention will become more readily appreciated when considered in connection with the following detailed description and appended drawings, wherein:

FIG. 1 schematically a side view of the device for connecting a capillary;

FIG. 2 schematically a section view of the device of FIG. 1; and

FIG. 3 schematically a side view of the device of FIG. 1 with fitted capillary and sleeve.

### DETAILED DESCRIPTION OF THE INVENTION

In the following preferred exemplary embodiments are described with reference to the figures. Here identical, similar or elements appearing identically are denoted by using identical reference signs in the variety of figures. A description of said elements is thus not repeated in order to avoid redundancies.

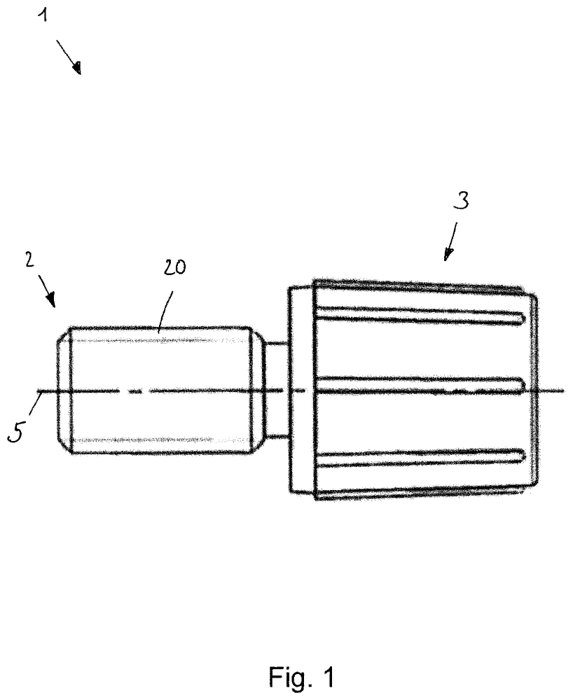

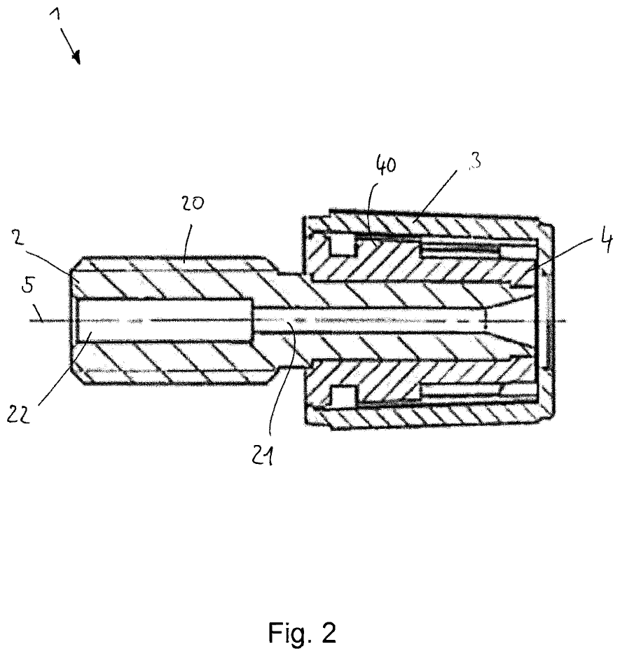

FIG. 1 schematically shows a side view of the device 1 for connecting a capillary. The device 1 comprises a core element 2 having a threaded portion 20 for connecting to a threaded connection bushing, and a cap element 3 which extends in a longitudinal direction 5 offset from the threaded portion 20 in the peripheral direction around the core element 2 with regard to the longitudinal direction. The core element 2 and the cap element 3 are rotationally coupled with one another in a way that an outer torque applied on the cap element 3 is transferred to the core element 2, wherein above a threshold of a torque in a screw-in rotational direction of the core element 2 a relative movement of the cap element 3 is performed relative to the core element 2 instead of the transfer of torque, as has been described with regard to FIG. 2.

FIG. 2 schematically shows a section view of the device 1 of FIG. 1. Between the core element 2 and the cap element 3 an intermediate element 4 for providing a coupling from the core element 2 to the cap element 3 is provided.

The core element 2 comprises a metal alloy. The cap element 3 comprises a plastic material. The intermediate element 4 comprises a plastic material which normally differs from the cap element 3.

The intermediate element 4 is fixedly arranged on the core element 2, wherein the core element 4 is thus a plastic overmolding which is applied to the core element 2.

In order to improve the transfer of torque between the core element 2 and the intermediate element, a positive locking may be formed in a positive locking section (not shown) between the intermediate element 4 and the core element 2 in the peripheral direction.

The intermediate element 4 comprises a plurality of resilient spring elements 40 which are arranged spaced apart from one another around the peripheral direction and are engaged with an engagement portion of the cap element 3. They are formed in a way that below the threshold a transfer of torque between the intermediate element 4 and the cap element 3 may be performed via the spring elements 40 in both rotational directions, and above the threshold in the screw-in rotational direction of the threaded portion 20 of the core element 2, the spring elements 40 may experience a resilient deformation, thus a relative movement between the cap element 3 and the intermediate element 4 and thus between the core element 2 and the cap element 3 is possible. In other words, this way a ratchet feature or function is provided. In addition, the spring elements 40 are configured in a way that a transfer of torque may always be performed against the screw-in rotational direction.

Here, the usually metal core element 2 is formed as turned part.

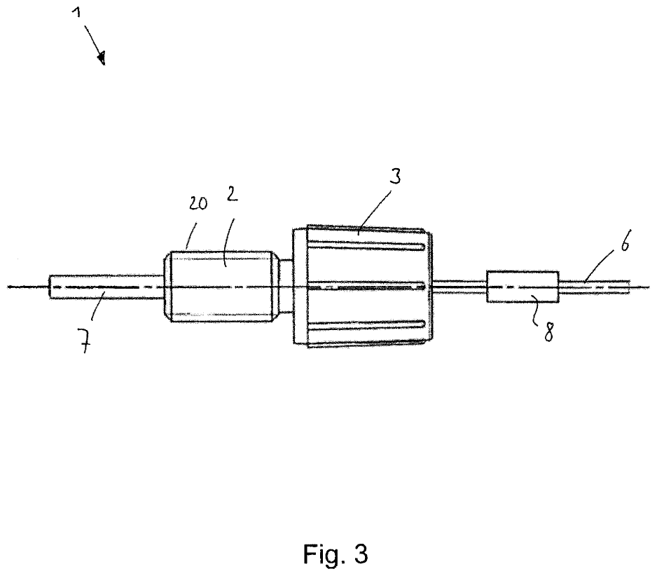

FIG. 3 schematically shows a side view of the device 1 from FIG. 1 including an inserted capillary 6 comprising a stopper 8 on the side of the cap element 3 and an inserted sleeve 7 on the side of the threaded portion 20.

Where applicable, any single features which are presented in the exemplary embodiments may be combined and/or replaced by one another without leaving the scope of the invention.

The foregoing invention has been described in accordance with the relevant legal standards, thus the description is exemplary rather than limiting in nature. Variations and modifications to the disclosed embodiment may become apparent to those skilled in the art and fall within the scope of the invention.

### LIST OF REFERENCE SIGNS

1 Device
2 Core element
20 Threaded section
21 Axial passage
22 Blind hole
3 Cap element
4 Intermediate element
40 Spring element
5 Longitudinal direction
6 First capillary
7 Sleeve
8 Stopper

1. A device for connecting a tube, hose, or a capillary, comprising:
a core element having a threaded section for connecting to a connection bushing; and
a cap element which extends offset from the threaded section in the peripheral direction around the core element in a longitudinal direction,
wherein the core element and the cap element are rotationally coupled to one other in a way that a torque applied to the cap element is transferred to the core element, and above a threshold of the torque in a screw-in rotational direction of the core element a relative movement of the cap element is performed relative to the core element instead of a transfer of torque, and
wherein between the core element and the cap element an intermediate element for providing the coupling between the core element and the cap element is arranged.

2. The device according to claim 1, wherein:
the core element comprises a metal, a metal alloy or a plastic material;
the cap element comprises a plastic material;
the intermediate element comprises a plastic material;
the plastic material of the core element, the intermediate element, and/or the cap element is a plastic material which is reinforced by a reinforcing material, and the reinforcing material is ceramics, glass, or carbon, or is a composite material.

3. The device according to claim 2, wherein:
the plastic materials of the cap element and of the intermediate element differ from one another.

4. The device according to claim 1, wherein:
the intermediate element is fixedly arranged on the core element, wherein preferably the intermediate element is an overmolding, preferably a plastic overmolding, of the core element or that the intermediate element is applied on the core element by means of 3D printing, sintering, or pressing.

5. The device according to claim 1, wherein:
a positive locking between the intermediate element and the core element is formed in the positive locking section in the peripheral direction.

6. The device according to claim 1, wherein:
the intermediate element comprises at least one resilient spring element which is engaging with an engagement portion of the cap element;
the at least one resilient spring element is formed in a way that below the threshold a transfer of torque is performed in both rotational directions, and above the threshold the at least one resilient spring element experiences a resilient deformation in the screw-in rotational direction, thus a relative movement between the cap element and the intermediate element is possible.

7. The device according to claim 1, wherein:
the cap element comprises at least one resilient spring element which is engaging with an engagement portion of the intermediate element;
the at least one resilient spring element is formed in a way that below the threshold a transfer of torque is performed in both rotational directions, and above the threshold the at least one resilient spring element experiences a resilient deformation in the screw-in rotational direction; and
a relative movement between the cap element and the intermediate element is possible, wherein preferably the spring element is further configured in such a way.

8. The device according to claim 6, wherein:
the at least one resilient spring element is further configured in a way that a transfer of torque is always performed against the screw-in a rotational direction.

9. The device according to claim 1, wherein:
the core element is configured as turned part.

10. The device according to claim 1, wherein:
a sealing element, a pressure or thrust part, a rotational lock, a child-proof lock, and/or a predetermined breaking point is provided on the core element.
